(19) United States
(12) Patent Application Publication
(10) Pub. No.: US 2017/0016986 A1
(43) Pub. Date: Jan. 19, 2017

(54) SYSTEM AND METHOD FOR PROVIDING REMOTE TARGET IDENTIFICATION USING OPTICAL TAGGING

(71) Applicant: Thales-Raytheon Systems Company LLC, Fullerton, CA (US)

(72) Inventors: James W. Rakeman, Brea, CA (US); David E. Stephens, Chino Hills, CA (US); Thomas W. Miller, Yorba Linda, CA (US)

(21) Appl. No.: 14/802,634

(22) Filed: Jul. 17, 2015

(51) Int. Cl. G01S 13/86; G06K 7/10; G06K 7/14; G06K 19/06; G01S 7/41; G01S 13/66

(52) U.S. Cl. CPC G01S 13/86; G01S 7/41; G01S 13/66; G06K 7/1413; G06K 19/0614; G06K 7/10554

(57) ABSTRACT

A system for providing remote target identification is provided that includes a radar system and an electro-optical device. The radar system is configured to locate a remote target that has an optical identification (ID) system. The radar system is also configured to generate a target location when the target is located. The electro-optical device is configured to receive the target location from the radar system and to obtain optical data from the optical ID system based on the target location. The optical data includes an identity of the target.

### CROSS-REFERENCE TO RELATED APPLICATION

This application is related to U.S. patent application Ser. No. ______ (Attorney's Docket No. Raytheon 14-6605 (RAYN01-46605)) titled, “System and Method for Providing Remote Target Identification Using Radiofrequency Identification,” which is being filed concurrently herewith. This related application is hereby incorporated by reference in its entirety.

### TECHNICAL FIELD

The present disclosure is directed, in general, to radar targeting systems and, more specifically, to a system and method for providing remote target identification using optical tagging.

### BACKGROUND

On the battlefield, it is extremely important to be able to distinguish between enemy and friendly targets, such as unmanned aerial vehicles (UAVs), personnel and surface craft or vehicles. Currently, the solution to this problem for UAVs typically incudes the use of an on-board identification friend or foe (IFF) transponder to identify the UAV. However, on-board IFF transponders may only be used with relatively large UAVs due to the payload limitations of smaller UAVs.

### SUMMARY

This disclosure provides a system and method for providing remote target identification using optical tagging.

In one embodiment, a system for providing remote target identification is provided. The system includes a radar system and an electro-optical device. The radar system is configured to locate a remote target that has an optical identification (ID) system. The radar system is also configured to generate a target location when the target is located. The electro-optical device is configured to receive the target location from the radar system and to obtain optical data from the optical ID system based on the target location. The optical data includes an identity of the target.

In another embodiment, a system for providing remote target identification is provided. The system includes a radar system and an electro-optical device. The radar system is configured to locate a remote unmanned aerial vehicle (UAV) that has an optical ID system and to generate a UAV location when the UAV is located. The electro-optical device is configured to receive the UAV location from the radar system, to obtain optical data from the optical ID system based on the UAV location, to determine the identity of the UAV based on the optical data, and to provide the identity of the UAV to the radar system.

In yet another embodiment, a method for providing remote target identification is provided. The method includes locating a remote target that has an optical ID system. A target location is generated when the target is located. Optical data is obtained from the optical ID system based on the target location. An identity of the target is determined based on the optical data.

Other technical features may be readily apparent to one skilled in the art from the following figures, descriptions, and claims.

### BRIEF DESCRIPTION OF THE DRAWINGS

For a more complete understanding of the present disclosure, reference is now made to the following description taken in conjunction with the accompanying drawings, in which:

FIG. 1 illustrates a system for providing remote target identification in accordance with an embodiment of the present disclosure;

FIG. 2 illustrates details of the system of FIG. 1 in accordance with an embodiment of the present disclosure;

FIG. 3 is a flowchart illustrating a method for providing remote target identification using optical tagging in accordance with an embodiment of the present disclosure;

FIG. 4 illustrates details of the system of FIG. 1 in accordance with another embodiment of the present disclosure; and

FIGS. 5A-5B are flowcharts illustrating a method for providing remote target identification using radiofrequency identification in accordance with an embodiment of the present disclosure.

### DETAILED DESCRIPTION

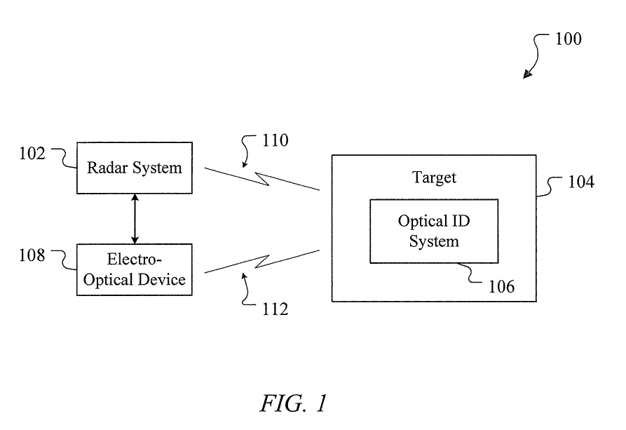

FIGS. 1 through 5B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented using any number of techniques, whether currently known or not. Additionally, the drawings are not necessarily drawn to scale.

FIG. 1 illustrates a system 100 for providing remote target identification in accordance with an embodiment of the present disclosure. The embodiment of the system 100 shown in FIG. 1 is for illustration only. Other embodiments of the system 100 could be used without departing from the scope of this disclosure.

For the illustrated embodiment, the system 100 includes a radar system 102, a remote target 104 with an optical identification (ID) system 106, and an electro-optical device 108. As used herein, a “remote” target 104 is a target 104 that may be located 2 km or more away from the radar system 102. The radar system 102 is configured to locate the target 104 using a radar signal 110. For some embodiments, the radar system 102 may be configured to detect and track relatively small targets 104, such as small UAVs. The optical ID system 106 is configured to provide optical data associated with the target 104 such that the target 104 may be identified based on that data. For some embodiments, the data may identify the target 104 uniquely (i.e., identify that particular target 104). For other embodiments, the data may identify a type of target (e.g., a UAV or a specific type of UAV), that the target 104 is friendly or a known entity to the radar system 102, or any other suitable characteristic of the target 104.

The electro-optical device 108 is configured to obtain (i.e., to scan, read, receive and/or otherwise obtain) the optical data provided by the optical ID system 106 through an optical signal 112. The electro-optical device 108 may also be configured to determine an identity of the target 104 based on the optical data and to determine a status of the target 104 based on the identity of the target 104. For example, the status of the target 104 may include whether or not the target 104 is friendly. The electro-optical device 108 is also configured to provide the identity and/or the status of the target 104 to the radar system 102.

The radar system 102 is configured to output the information provided by the electro-optical device 108 to a display screen (not shown in FIG. 1) or to otherwise suitably provide the information to an operator of the radar system 102. For example, the radar system 102 may generate a particular graphic related to each target 104 being tracked to identify whether the target 104 is friendly or not. For a particular example, a first symbol and/or a first color may indicate a friendly target 104, while a second or third symbol and/or a second or third color may indicate an enemy or unknown target.

The electro-optical device 108 may be co-mounted and north-aligned with the radar system 102. In addition, the electro-optical device 108 may be coupled to the radar system 102 through an electronic interface, such as a serial, Ethernet or other suitable interface. For some embodiments, the optical ID system 106 may be configured to generate the optical signal 112 to actively provide the optical data to the electro-optical device 108. However, for other embodiments, the optical ID system 106 may be configured to passively provide the optical data, while the electro-optical device 108 is configured to generate the optical signal 112 to obtain the optical data from the optical ID system 106.

In this way, the system 100 may identify, and determine a status for, a remote target 104 using a low-cost, lightweight and compact solution that may be implemented even with relatively small targets 104, such as small UAVs. Because the cost of destroying friendly UAVs can be $50,000-$250,000 or more and the cost of not destroying enemy UAVs is immeasurable (potentially exceeding millions of dollars in tactical compromise and possible loss of human life), this relatively low-cost system 100 provides a substantial advantage on the battlefield. In addition, the system 100 may be implemented in situations other than battlefields. For example, the target 104 may be a commercial or small, personal or civilian aircraft. For this example, the system 100 may be able to identify an aircraft even if its transponder is malfunctioning or has been intentionally disabled.

Although FIG. 1 illustrates one example of a system 100 for providing remote target identification, various changes may be made to the embodiment shown in FIG. 1. For example, the makeup and arrangement of the system 100 are for illustration only. Components could be added, omitted, combined, subdivided, or placed in any other suitable configuration according to particular needs.

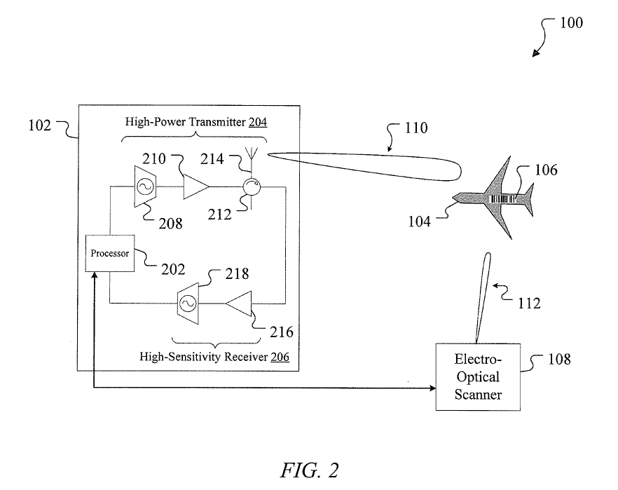

FIG. 2 illustrates details of the system 100 in accordance with an embodiment of the present disclosure. For the illustrated embodiment, the system 100 is configured to provide remote target identification using optical tagging. The embodiment of the system 100 shown in FIG. 2 is for illustration only. Other embodiments of the system 100 could be used without departing from the scope of this disclosure.

For this embodiment, the electro-optical device is represented by an electro-optical scanner 108, the target is represented by an unmanned aerial vehicle (UAV) 104, and the optical ID system is represented by an optical code 106. The optical code 106, which may be coupled to the UAV 104 in any suitable manner, includes data associated with the UAV 104 such that the UAV 104 may be identified based on that data. As described in connection with FIG. 1, the data may identify the particular UAV 104, a type of the UAV 104, that the UAV 104 is friendly, or the like. The optical code 106 may include a barcode, be color-coded, use retro-reflector technology, or include any other suitable visual data.

For the illustrated embodiment, the radar system 102 includes a processor 202, a high-power transmitter 204 and a high-sensitivity receiver 206. The processor 202 is coupled to the transmitter 204 and the receiver 206, as well as to the electro-optical scanner 108. The transmitter 204 includes a signal/waveform generator 208, a high-power amplifier 210, a circulator/duplexer 212 and a high-gain antenna 214. The receiver 206 includes a low-noise receiver 216 and a demodulator 218. For some embodiments, the signal/waveform generator 208 and the demodulator 218 may each include a frequency converter.

The processor 202 is configured to provide radar detection and tracking of the UAV 104 through the transmitter 204 and the receiver 206, as indicated by the radar signal 110, which may represent a high-gain antenna beam. After the UAV 104 is located by the radar system 102, the processor 202 is also configured to notify the electro-optical scanner 108 of the location of the UAV 104.

Based on the UAV location, the electro-optical scanner 108 is configured to scan the optical code 106 on the UAV 104 using the optical signal 112 (either actively or passively). The electro-optical scanner 108 is also configured to read optical data provided in the optical code 106. For some embodiments, the electro-optical scanner 108 is configured to determine an identity of the UAV 104 based on the optical data and to determine a status of the UAV 104 (e.g., friendly or enemy or unknown) based on the determined identity. The electro-optical scanner 108 is also configured to provide the identity and/or the status of the UAV 104 to the processor 202 of the radar system 102.

Although FIG. 2 illustrates one example of a system 100 for providing remote target identification using optical tagging, various changes may be made to the embodiment shown in FIG. 2. For example, the makeup and arrangement of the system 100 are for illustration only. Components could be added, omitted, combined, subdivided, or placed in any other suitable configuration according to particular needs.

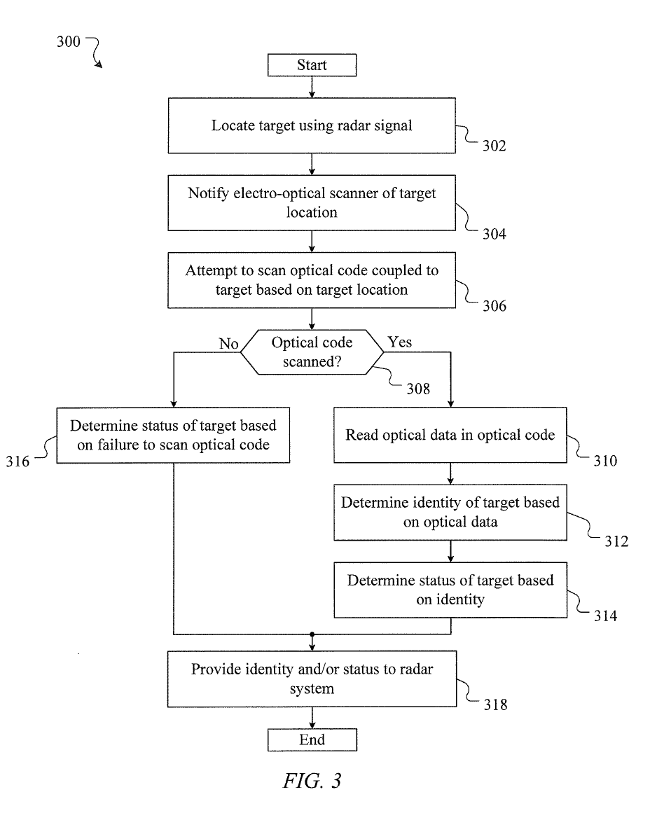

FIG. 3 is a flowchart illustrating a method 300 for providing remote target identification using optical tagging in accordance with an embodiment of the present disclosure. The method 300 shown in FIG. 3 is for illustration only. Remote target identification using optical tagging may be provided in any other suitable manner without departing from the scope of this disclosure.

Initially, a radar system 102 locates a target (such as a UAV or other suitable target) using a radar signal 110 (step 302). The radar system 102 notifies an electro-optical scanner 108 of the location of the target (step 304). For example, in some embodiments, a processor 202 of the radar system 102 notifies the electro-optical scanner 108 of the location. Based on the target location provided by the radar system 102, the electro-optical scanner 108 attempts to scan an optical code 106 coupled to the target (step 306).

If the target 104 includes an optical code 106 and the electro-optical scanner 108 successfully scans the optical code 106 (step 308), the electro-optical scanner 108 reads optical data included in the optical code 106 (step 310) and determines an identity of the target 104 based on the optical data (step 312). For example, in some embodiments, the electro-optical scanner 108 may determine an identity of the particular target 104, an identity of a type of the target 104, or the like.

The electro-optical scanner 108 determines a status of the target 104 based on the identity (step 314). For example, in some embodiments, the electro-optical scanner 108 may determine that the status of the target 104 is “friendly” if the target 104 has been identified (i.e., the target 104 has an optical code 106 that was able to be scanned) or if the determined identity corresponds to a known friendly target 104.

If the target located by the radar system 102 does not include an optical code 106, when the electro-optical scanner 108 attempts to scan an optical code 106 (step 306), no optical code 106 is successfully scanned (step 308) and, thus, the electro-optical scanner 108 determines a status of the target based on the failure to scan an optical code 106 (step 316). For example, in some embodiments, the electro-optical scanner 108 may determine that the status of the target is “enemy” (or “unknown”) based on the failure to scan an optical code 106.

After determining a status of the target 104 (step 314) or target (step 316), the electro-optical scanner 108 provides the identity and/or the status to the radar system 102 (step 318). For example, in some embodiments, the electro-optical scanner 108 may provide the identity and/or the status to the processor 202 of the radar system 102.

Although FIG. 3 illustrates one example of a method 300 for providing remote target identification using optical tagging, various changes may be made to the embodiment shown in FIG. 3. For example, while shown as a series of steps, various steps in FIG. 3 could overlap, occur in parallel, occur in a different order, or occur multiple times. For a specific example, the electro-optical scanner 108 may provide the optical data to the radar system 102, and the radar system 102 may then determine the identity of the target 104 based on the optical data and the status of the target 104 based on the identity. As another alternative, the electro-optical scanner 108 may determine the identity of the target 104 based on the optical data and provide the identity to the radar system 102, and the radar system 102 may then determine the status of the target 104 based on the identity. In addition, for some embodiments, the determined identity may include an identity of the status of the target 104 (e.g., that the target 104 is friendly). For these embodiments, a separate determination of the status of the target 104 may be omitted.

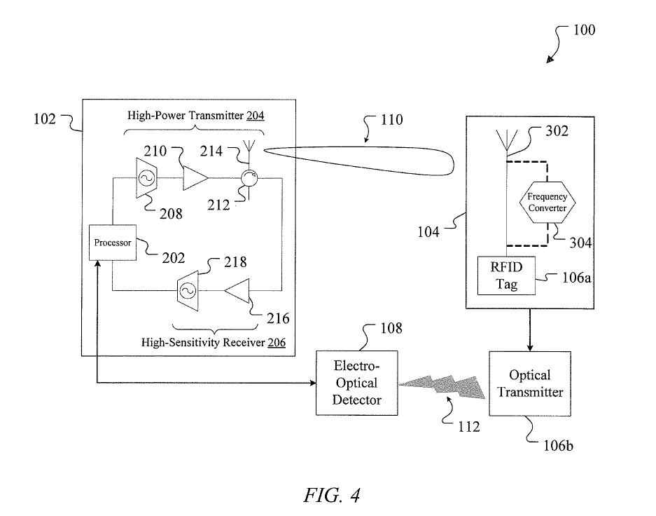

FIG. 4 illustrates details of the system 100 in accordance with another embodiment of the present disclosure. For the illustrated embodiment, the system 100 is configured to provide remote target identification using radiofrequency identification (RFID). The embodiment of the system 100 shown in FIG. 4 is for illustration only. Other embodiments of the system 100 could be used without departing from the scope of this disclosure.

For this embodiment, the radar system 102 includes a processor 202, a high-power transmitter 204 and a high-sensitivity receiver 206, and the target 104 includes an RFID antenna 302, an optional frequency converter 304, and an RFID tag 106a. The RFID tag 106a, which may be passive, semi-active or active, includes data associated with the target 104 such that the target 104 may be identified based on that data. As described in connection with FIG. 1, the data may identify the particular target 104, a type of the target 104, that the target 104 is friendly, or the like. Also, for this embodiment, the electro-optical device is represented by an electro-optical detector 108 and the optical ID system is represented by the RFID tag 106a and an optical transmitter 106b, each of which may be coupled to the target 104 in any suitable manner.

The processor 202 is coupled to the transmitter 204 and the receiver 206, as well as to the electro-optical detector 108. The transmitter 204 includes a signal/waveform generator 208, a high-power amplifier 210, a circulator/duplexer 212 and a high-gain antenna 214. The receiver 206 includes a low-noise receiver 216 and a demodulator 218. For some embodiments, the signal/waveform generator 208 and the demodulator 218 may each include a frequency converter.

The processor 202 is configured to provide radar detection and tracking of the target 104 through the transmitter 204 and the receiver 206, as indicated by the radar signal 110, which may include an interrogation waveform generated by the radar system 102. After the target 104 is located by the radar system 102, the processor 202 is also configured to notify the electro-optical detector 108 of the location of the target 104.

The target 104 is configured to receive the radar signal 110 at the RFID antenna 302 and, based on the radar signal 110 (i.e., the interrogation waveform), the RFID tag 106a is configured to provide the identifying data that is associated with the target 104 to the optical transmitter 106b. The frequency converter 304 may be configured to up-convert or down-convert the frequency of the radar signal 110. Thus, for embodiments in which the frequency of the radar system 102 is different from the frequency used by the RFID tag 106a, the optional frequency converter 304 may be included as part of the target 104. For example, including the frequency converter 304 allows a commercial RFID tag 106a to be used in conjunction with a high-performance military or commercial radar system 102.

The optical transmitter 106b, which includes a light source (such as a light-emitting diode or the like in the visible or non-visible radiofrequency spectrum), is configured to generate an optical signal 112 based on the identifying data provided by the RFID tag 106a and to optically transmit the optical signal 112 via the light source. For example, the optical transmitter 106b may be configured to flash the light source in a particular pattern, at a particular frequency, or in any other suitable manner so as to transmit the optical signal 112. The electro-optical detector 108 is configured to detect the optical signal 112 transmitted from the optical transmitter 106b based on the target location provided by the processor 202 and to decode the optical signal 112 in order to extract the identifying data.

For some embodiments, the electro-optical detector 108 is also configured to determine the identity of the target 104 based on the identifying data and to determine a status of the target 104 (e.g., whether the target 104 is friendly or enemy or unknown) based on the determined identity. The electro-optical detector 108 is also configured to provide the identity and/or the status of the target 104 to the processor 202 of the radar system 102.

Although FIG. 4 illustrates one example of a system 100 for providing remote target identification using radiofrequency identification, various changes may be made to the embodiment shown in FIG. 4. For example, the makeup and arrangement of the system 100 are for illustration only. Components could be added, omitted, combined, subdivided, or placed in any other suitable configuration according to particular needs.

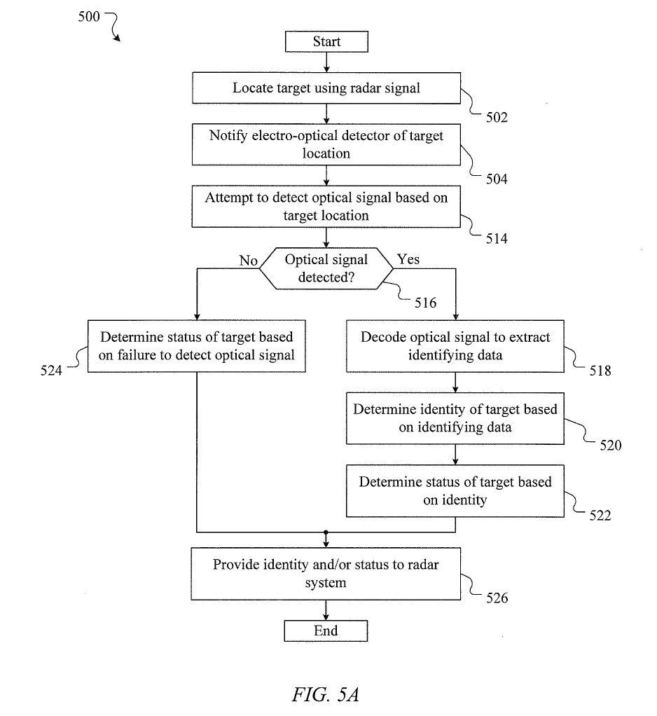

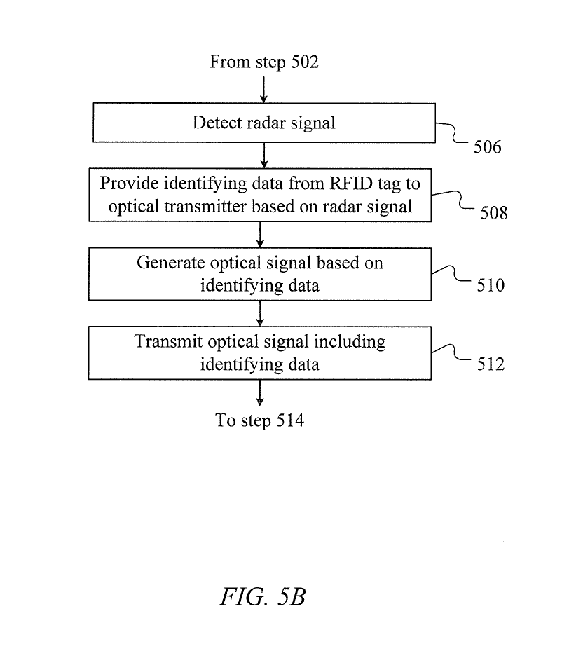

FIGS. 5A-5B are flowcharts illustrating a method 500 for providing remote target identification using radiofrequency identification in accordance with another embodiment of the present disclosure. The method 500 shown in FIGS. 5A-5B is for illustration only. Remote target identification using radiofrequency identification may be provided in any other suitable manner without departing from the scope of this disclosure.

FIG. 5A illustrates a portion of the method 500 from the perspective of the radar system 102 and the electro-optical detector 108, while FIG. 5B illustrates a portion of the method 500 from the perspective of the target 104. Thus, the portion of the method 500 of FIG. 5B may be incorporated as part of the method 500 of FIG. 5A when the target 104 is identifiable by the electro-optical detector 108. However, when a target does not include an optical ID system 106, the portion of the method 500 shown in FIG. 5B is omitted.

Initially, a radar system 102 locates a target using a radar signal 110 (step 502). For example, in some embodiments, the radar system 102 may locate a target using a radar signal 110 that includes an interrogation waveform. The radar system 102 notifies an electro-optical detector 108 of the location of the target 104 (step 504). For example, in some embodiments, a processor 202 of the radar system 102 notifies the electro-optical detector 108 of the location.

As shown in FIG. 5B, if the target 104 includes an optical ID system 106, the target 104 detects the radar signal 110 generated by the radar system 102 (step 506). Based on the interrogation waveform included in the radar signal 110, the target 104 provides identifying data from the RFID tag 106a to the optical transmitter 106b (step 508). The optical transmitter 106b generates an optical signal 112 based on the identifying data provided from the RFID tag 106a (step 510) and transmits the optical signal 112 including the identifying data (step 512).

As shown in FIG. 5A, based on the target location provided by the radar system 102, the electro-optical detector 108 attempts to detect an optical signal 112 (step 514). If the target 104 includes an optical ID system 106, the electro-optical detector 108 detects the optical signal 112 transmitted by the optical transmitter 106b (step 516) and decodes the optical signal 112 to extract the identifying data (step 518). The electro-optical detector 108 determines an identity of the target 104 based on the identifying data (step 520). For example, in some embodiments, the electro-optical detector 108 may determine an identity of the target 104, such as an identity of the particular target 104, an identity of a type of the target 104, or the like.

The electro-optical detector 108 determines a status of the target 104 based on the determined identity (step 522). For example, in some embodiments, the electro-optical detector 108 may determine that the status of the target 104 is “friendly” if the target 104 has been identified (i.e., the target 104 has provided a detectable optical signal 112) or if the determined identity corresponds to a known friendly target 104.

If the target located by the radar system 102 does not include an optical ID system 106, when the electro-optical detector 108 attempts to detect an optical signal 112 (step 514), no optical signal 112 is detected (step 516) and, thus, the electro-optical detector 108 determines a status of the target based on the failure to detect the optical signal 112 (step 524). For example, in some embodiments, the electro-optical detector 108 may determine that the status of the target is “enemy” (or “unknown”) based on the failure to detect the optical signal 112.

After determining the status of the target 104 (step 522) or the target (step 524), the electro-optical detector 108 then provides the identity and/or the status to the radar system 102 (step 526). For example, in some embodiments, the electro-optical detector 108 may provide the identity and/or status to the processor 202 of the radar system 102.

Although FIG. 5 illustrates one example of a method 500 for providing remote target identification using radiofrequency identification, various changes may be made to the embodiment shown in FIG. 5. For example, while shown as a series of steps, various steps in FIG. 5 could overlap, occur in parallel, occur in a different order, or occur multiple times. For a specific example, the electro-optical detector 108 may provide the optical data to the radar system 102, and the radar system 102 may then determine the identity of the target 104 based on the optical data and the status of the target 104 based on the identity. As another alternative, the electro-optical detector 108 may determine the identity of the target 104 based on the optical data and provide the identity to the radar system 102, and the radar system 102 may then determine the status of the target 104 based on the identity. In addition, for some embodiments, the determined identity may include an identity of the status of the target 104 (e.g., that the target 104 is friendly). For these embodiments, a separate determination of the status of the target 104 may be omitted.

Modifications, additions, or omissions may be made to the apparatuses and methods described here without departing from the scope of the disclosure. For example, the components of the apparatuses may be integrated or separated. The methods may include more, fewer, or other steps. Additionally, as described above, steps may be performed in any suitable order.

It may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The term “each” refers to each member of a set or each member of a subset of a set. Terms such as “over” and “under” may refer to relative positions in the figures and do not denote required orientations during manufacturing or use. Terms such as “higher” and “lower” denote relative values and are not meant to imply specific values or ranges of values. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system for providing remote target identification, comprising:
a radar system configured to locate a remote target comprising an optical identification (ID) system and to generate a target location when the target is located; and
an electro-optical device configured to receive the target location from the radar system and to obtain optical data from the optical ID system based on the target location, wherein the optical data comprises an identity of the target.

2. The system of claim 1, wherein the electro-optical device is further configured to determine the identity of the target based on the optical data and to provide the identity of the target to the radar system.

3. The system of claim 1, wherein the electro-optical device is further configured to determine the identity of the target based on the optical data, to determine a status of the target based on the identity of the target, and to provide the status of the target to the radar system.

4. The system of claim 3, wherein the status comprises one of friendly, enemy and unknown.

5. The system of claim 1, wherein the electro-optical device comprises an electro-optical scanner.

6. The system of claim 5, wherein the optical ID system comprises a barcode.

7. The system of claim 6, wherein the barcode comprises the optical data, and wherein the electro-optical scanner is configured to obtain the optical data from the optical ID system by scanning the barcode and reading the optical data in the barcode.

8. The system of claim 1, wherein the optical ID system is configured to implement one of color-coding and retro-reflector technology.

9. A system for providing remote target identification, comprising:
a radar system configured to locate a remote unmanned aerial vehicle (UAV) comprising an optical identification (ID) system and to generate a UAV location when the UAV is located; and
an electro-optical device configured to receive the UAV location from the radar system, to obtain optical data from the optical ID system based on the UAV location, to determine the identity of the UAV based on the optical data, and to provide the identity of the UAV to the radar system.

10. The system of claim 9, wherein the electro-optical device is further configured to determine a status of the UAV based on the identity of the UAV and to provide the status of the UAV to the radar system.

11. The system of claim 10, wherein the status comprises one of friendly, enemy and unknown.

12. The system of claim 9, wherein the electro-optical device comprises an electro-optical scanner.

13. The system of claim 12, wherein the optical ID system comprises a barcode, wherein the barcode comprises the optical data, and wherein the electro-optical scanner is configured to obtain the optical data from the optical ID system by scanning the barcode and reading the optical data in the barcode.

14. The system of claim 9, wherein the optical ID system is configured to implement one of color-coding and retro-reflector technology.

15. A method for providing remote target identification, comprising:
locating a remote target comprising an optical identification (ID) system;
generating a target location when the target is located;
obtaining optical data from the optical ID system based on the target location; and
determining an identity of the target based on the optical data.

16. The method of claim 15, further comprising determining a status of the target based on the identity of the target.

17. The method of claim 16, wherein the status comprises one of friendly, enemy and unknown.

18. The method of claim 15, further comprising:
locating a second remote target;
generating a second target location when the second target is located;
attempting to obtain optical data from the second target based on the second target location; and
determining a status of the second target based on a failure to obtain optical data from the second target.

19. The method of claim 15, wherein the optical ID system comprises a barcode, wherein the barcode comprises the optical data, and wherein obtaining optical data from the optical ID system comprises scanning the barcode and reading the optical data in the barcode.

20. The method of claim 15, wherein the optical ID system is configured to implement one of color-coding and retro-reflector technology.
